(19) United States
(12) Patent Application Publication
(10) Pub. No.: US 2023/0267549 A1
(43) Pub. Date: Aug. 24, 2023

(54) Method of predicting the future accident risk rate of the drivers using artificial intelligence and its device

(71) Applicant: CARVI INC., Seoul (KR)

(72) Inventor: Eunsu LEE, Seoul (KR)

(21) Appl. No.: 17/818,960

(22) Filed: Aug. 10, 2022

(30) Foreign Application Priority Data
Feb. 21, 2022 (KR) 10-2022-0021926

(51) Int. Cl. G06Q 40/08; H04W 4/029

(52) U.S. Cl. CPC G06Q 40/08; H04W 4/029; G06N 3/04

(57) ABSTRACT

Disclosed is a device of predicting future accident risk rate, including: a driving habit data collection device comprising a driving habit data collection unit that has a GPS, an IMU sensor, and a vision sensor to collect vehicle driving information per trip, and a CPU that manages the collection of driving habit data; a driving habit data storage server for storing driving habit data from the driving habit data collection unit; a main server including a main database for receiving driving habit data of the driving habit data storage server, a data pre-processing unit for pre-processing driving habit data of the main database for each variable, an artificial intelligence model that predicts accident risk of vehicle driving by inputting the data preprocessed in the data pre-processor, an accident risk database that stores accident risk output from the artificial intelligence model, and a control unit that manages accident risk prediction.

### CROSS-REFERENCE TO RELATED APPLICATIONS

This application claims priority from Korean Patent Application No.10-2022-0021926, filed on Feb. 21, 2022, in the Korean Intellectual Property Office, the disclosure of which is incorporated herein by reference in its entirety.

### BACKGROUND OF THE INVENTION

### Field of the Invention

The present invention relates to a method of predicting the future accident risk rate of the drivers using artificial intelligence such as machine learning or deep learning, and its device, and more particularly, the method of predicting the future accident risk rate of the drivers using artificial intelligence and its device such as machine learning or deep learning based on vehicle driving habit data collected from GPS, IMU sensor, and vision sensor, and its device.

### Background Technology Description of the Related Art

In car insurance, it is very important to estimate the probability that a driver will cause an accident and the amount of compensation accordingly. This is directly related to the profit of the insurance product, and if the forecast is wrong, a loss may occur.

Specifically, in car insurance, the loss ratio, which is the value obtained by dividing the cost of insurance, such as insurance money, by the insurance premium received from the insured, is used as an index. In order to lower the loss ratio, insurance companies find drivers with high accident risk and either charge high insurance premiums or refuse to take over. Drivers with a low risk of accidents can be encouraged to sign up by lowering insurance premiums or providing incentives.

In order to manage the loss ratio, insurance companies are using each driver’s personal information, vehicle type, and accident history to determine insurance premiums for each driver.

Republic of Korea Patent No. 2318801, “Driver’s Traffic Accident Rate Prediction System” discloses a driver’s traffic accident prediction system that predicts the accident rate that may occur in the future for each driver based on personal information, violation information related to past driving, and accident information.

However, it is difficult to accurately grasp the unique driving habits of each driver and the risk factors inherent in these driving habits from a simple accident history.

Therefore, in recent years, various attempts have been made to collect information on the driver’s driving habits, perform an analysis based on this information, and to objectify potential risk factors inherent in the driver’s driving habits as a basis for calculating insurance premiums.

There is a prior art that collects driving habit data such as speeding, rapid acceleration, and deceleration using a driving collection terminal such as GPS and OBD (On-Board Diagnostic). For example, there are T-map driving score-linked discount and Carrot Insurance’s mileage-based per mile insurance products in Republic of Korea, which is called UBI (Usage Based Insurance). However, the current UBI on the market uses only data such as speeding/rapid acceleration/deceleration, which are information that does not take into account the driving context, so it is often difficult to derive accurate driving habits. For example, in the case of a sudden deceleration, it is difficult to determine whether the sudden deceleration is due to the risk of an accident or whether it is a simple driving habit unique to the driver, so it is difficult to derive a correlation with an actual traffic accident.

In order to improve this situation, the insurance industry proposes a driving habit-based insurance BBI (Behavior Based Insurance) product as a next-level technology product for UBI. An example of such a BBI is Tesla’s driving habit-based insurance.

### CITED REFERENCE

### Patent Document

(Patent Document 1) Korean Patent No. 10-1473866 (IMAGE PROCESSING SYSTEM FOR VEHICLE AND IMAGE PROCESSING METHOD OF USING THE SAME, Dec. 17, 2014)
(Patent Document 2) Korean Patent No. 10-2153912 (DEVICE AND METHOD FOR INSURANCE UNFAIR CLAIM AND UNFAIR PATTERN DETECTION BASED ON ARTIFICIAL INTELLIGENCE, Sep. 09, 2020)
(Patent Document 3) Korean Patent No. 10-2207494 (PROPERTY INSURANCE INSPECTIONS SYSTEM USING ARTIFICIAL INTELLIGENCE NETWORK, Jan. 26, 2021)
(Patent Document 4) Korean Patent No. 10-2312984 (APPARATUS AND METHOD FOR PROVIDING DRIVER INSURANCE PRODUCT BASED ON DRIVING INFORMATION, Oct. 14, 2021)
(Patent Document 5) Korean Patent No. 10-2030583 (Artificial intelligence based traffic accident prediction system and method, Oct. 11, 2019)
(Patent Document 6) Korean Patent No. 10-2318801 (Driver traffic accident rate prediction system, Oct. 28, 2021)
(Patent Document 7) Korean Patent Publication No. 10-2016-0019331 (Car insurance calculation system, Feb. 19, 2016)
(Patent Document 8) Korean Patent Publication No. 10-2021-0035478 (METHOD, APPARATUS AND PROGRAM FOR PROVIDING STATISTICAL ANALYSIS OF CAR INSURANCE BASED ON BIG DATA, Apr. 01, 2021)

### SUMMARY OF THE INVENTION

The present invention has been devised in view of the above-described problems, and its purpose is providing the method of predicting the future accident risk rate of the drivers using artificial intelligence and its device that can be used for insurance premium calculations by analyzing the driver’s driving propensity.

Device of predicting the future accident risk rate of the drivers using artificial intelligence of the present invention for solving the above problems includes: a driving habit data collection device comprising a driving habit data collection unit that has built-in GPS, IMU sensor, and a vision sensor to collect vehicle driving information per trip, and a CPU that manages the collection of driving habit data; a driving habit data storage server for storing driving habit data collected from the driving habit data collection unit; and a main server including a main database for receiving the driving habit data of the driving habit data storage server, a data pre-processing unit for pre-processing the driving habit data of the main database for each variable, an artificial intelligence model that predicts the accident risk of vehicle driving by inputting the data preprocessed in the data pre-processing unit, an accident risk database that stores the accident risk output from the artificial intelligence model, and a control unit that manages the accident risk prediction.

Preferably, each driving habit data pre-processed for each variable includes longitude, latitude, and altitude from GPS; accelerations in the x, y, and z-axis directions (ax, ay, az) from the IMU and angular accelerations in the x, y, and z-axis directions (gx, gy, gz); and distance from the vision sensor to the front vehicle(front_distance), the speed of the front vehicle (front_speed), the bias of the subject vehicle in the center of the lane (bias), the estimated time until collision with the front vehicle (ttc).

Preferably, further comprising an insurance server that differentiates car insurance premiums for each driver based on the accident risk that is the output value of the artificial intelligence model from the main server.

Preferably, a trip, which is a driving unit, is defined as the time from turning on the ignition of the vehicle to ending the starting. The vehicle driving data collected by the driving habit data collection device has a configuration including all variables per one trip, the data pre-processing unit stores the data of each sensor value as a time frame once at a predetermined time so that it is easier to handle the driving habit data, and all files corresponding to the same sensor value are merged and stored as one file.

Preferably, the data pre-processing unit performs feature engineering, in the feature engineering, driving habit data is stored as an average value once at a predetermined time.

Preferably, the artificial intelligence model is any one selected from random forest, XGBoost, Multi-Layer Perceptron (MLP), Long Short Term Memory (LSTM), and Convolutional Neural Network (CNN).

The method of predicting the future accident risk rate of the drivers using artificial intelligence of the present invention for solving the above other problems includes: collecting driving habit data from the driving habit data collection device through a driving habit data collection unit having a GPS, IMU sensor, and vision sensor; storing the driving habit data collected by the driving habit data collection device in a driving habit data storage server; transmitting the driving habit data stored in the driving habit data storage server to the main database of the main server; performing a pre-processing of driving habit data in the data pre-processing unit of the main server; obtaining an output value by inputting preprocessed data into the artificial intelligence model of the main server; and storing the output value of the artificial intelligence model of the main server in an accident risk database, and predicting the accident risk of the driver’s vehicle using the output value.

Preferably, the pre-processing in the data pre-processing unit of the main server is, further comprising a generating processed data by performing a feature engineering of extracting features by using domain knowledge of driving habit data in order to apply them to the artificial intelligence model.

According to the present invention having the above-described configuration, vehicle driving habit data is applied to an artificial intelligence model to predict an individual driver’s accident risk, and this accident risk can be used for insurance premium calculation and the like.

In addition, before applying to the AI model, it is possible to pre-process the variables of the vehicle driving habit data to make it easier to handle in the AI model.

Since there is a limit of memory to take all of the driving time of drivers into account, data corresponding to a time frame of a certain time is stored as a median value rather than an average value. It is possible to alleviate the bouncing data numerical values due to the smoothing effect that occurs when the average value is stored.

In addition, the vehicle driving habit data collected in the present invention uses a driving habit data collection device separately installed in the vehicle equipped with a Global Positioning System (GPS), an Inertial Measurement Unit (IMU) sensor, and a vision sensor. In particular, the data collected through the camera of the vision sensor, such as the speed of the front vehicle, the distance between the front vehicle and subject vehicle, the estimated time it takes to collide with the front vehicle, and the degree of deviation of the subject vehicle from the center of the lane, are contextual data and are actually related to a traffic accident. The prior art using a driving collection terminal such as GPS and OBD (On-Board Diagnostic) does not use a camera, so it is impossible to secure driving contextual data as described above.

In addition, the driving habit data collection device is recognized individually, and through this, it is possible to predict the accident risk of an individual vehicle or driver.

### BRIEF DESCRIPTION OF THE DRAWING FIGURES

The above object and advantages of the present invention will become more apparent by describing in detail exemplary embodiments thereof with reference to the attached drawings in which:

FIG. 1 is a conceptual diagram illustrating a device of predicting the future accident risk rate of the drivers using artificial intelligence according to an embodiment of the present invention.

FIG. 2 is a flowchart illustrating a method of predicting the future accident risk rate of the drivers using artificial intelligence according to an embodiment of the present invention.

FIG. 3 is a diagram illustrating a data processing method in a preprocessing process according to an embodiment of the present invention.

FIG. 4 is a diagram illustrating an output result of a random forest model according to an embodiment of the present invention.

FIG. 5 is a diagram illustrating a Multi-Layer Perceptron (MLP) algorithm according to an embodiment of the present invention.

FIG. 6 is a diagram illustrating a Long Short Term Memory (LSTM) algorithm according to an embodiment of the present invention.

FIG. 7 is a diagram illustrating a 1D Convolutional Neural Network (CNN) algorithm according to an embodiment of the present invention.

FIG. 8 is a diagram illustrating prediction performance of AI-based models according to an embodiment of the present invention.

### DETAILED DESCRIPTION OF THE EXEMPLARY EMBODIMENTS

Hereinafter, the method of predicting the future accident risk rate of the drivers using artificial intelligence and its device according to a preferred embodiment of the present invention will be described in detail with reference to the accompanying drawings.

The present invention predicts the accident risk of each driver by applying vehicle driving habit data to an artificial intelligence model.

Driving habit data in the present invention means data collected from a global positioning system (GPS), an inertial measurement unit (IMU) sensor, and a vision sensor. If other sensors are added to the driving habit data collection device 100, the types of driving habit data may be increased.

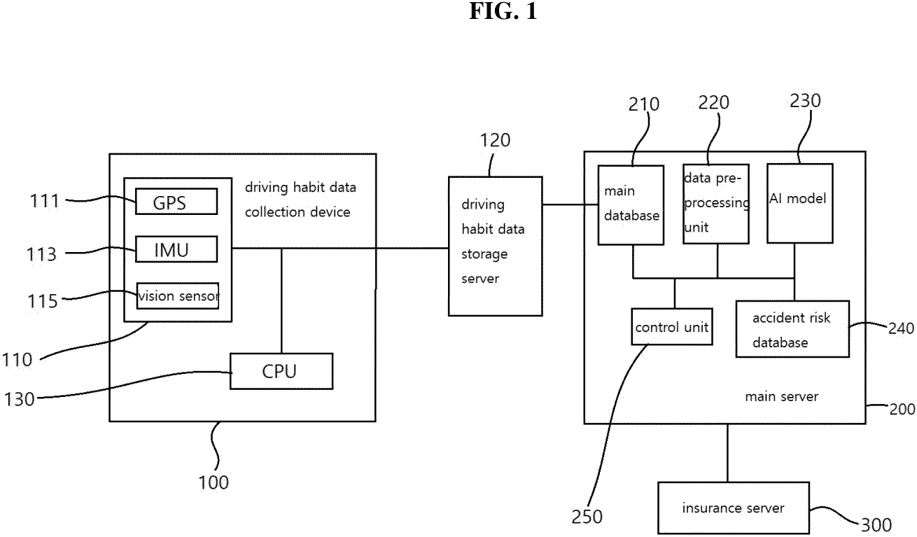

FIG. 1 is a conceptual diagram illustrating a device of predicting the future accident risk rate of the drivers using artificial intelligence according to an embodiment of the present invention.

Referring to FIG. 1, the driving habit data collection device 100 includes a driving habit data collection unit 110 for detecting vehicle driving habit data. A driving habit data storage server 120 stores driving habit data collected in real time by the driving habit data collection unit 110 . A main server 200 receives the driving habit data from the driving habit data storage server 120 and stores it in the main database, pre-processes the driving habit data, and outputs the accident prediction in the artificial intelligence model. An insurance server 300 receives the accident prediction data from the main server 200 and reflects it in the insurance premium for each driver.

The driving habit data collection device 100 includes a driving habit data collection unit 110 that detects vehicle driving information and a CPU 130 that manages the driving habit data collection of the driving habit data collection device 100.

The driving habit data collection device 100 is individually recognized, and through this, it is possible to predict the accident risk of an individual vehicle or driver. The driving habit data collection device 100 may receive information of a specific vehicle being driven or a specific driving driver. As a method in which the driving habit data collection device 100 receives information of a specific driver, it may be recognized in conjunction with a mobile terminal.

The driving habit data collection unit 110 collects vehicle driving habit data in real time from the GPS 111, the IMU 113 sensor, and the vision sensor 115. If necessary, the driving habit data collection unit 110 may include other sensors.

The GPS 111 is a satellite-based positioning data providing system, and the GPS receiver calculates a distance by referring to satellite radio waves. The GPS 111 calculates a distance by calculating a time taken for a signal transmitted from a satellite to arrive at a receiving device (TOA: Time of Arrival). Specifically, in the present invention, information of longitude, latitude, and altitude is collected from the GPS 111 in real time.

The IMU 113 refers to a device that measures the speed, direction, gravity, and acceleration of a moving object, and is a sensor-based device. IMU-based position estimation is a method of recognizing the movement situation of a moving object using an accelerometer, angular accelerometer, geomagnetism and altimeter. In the present invention, information on accelerations (ax, ay, az) in the x, y, and z-axis directions and angular accelerations (gx, gy, gz) in the x, y, and z-axis directions are collected in real time. In the present invention, the geomagnetic sensor among the IMU sensors is excluded because a unique correction value exists for each device mounted on the driver’s vehicle.

The vision sensor 115 is a sensor capable of discriminating a color, shape, size, character, pattern, etc. using a camera. In the present invention, images are collected from a camera in real time and information is collected in seconds using an algorithm. The information includes the distance between the front vehicle and subject vehicle (front_distance), the speed of the front vehicle (front_speed), the bias of the subject vehicle in the center of the lane (bias), and the estimated time it takes to collide with front vehicle and subject vehicle (ttc). The information is the driving habit data that the inventor has researched and developed for a long time and can be obtained from the image. The inventor’s image processing technology is disclosed in U.S. Application No. 17/159,150; U.S. Application No. 17/029,071; U.S. Application No. 17/805,124.

The driving habit data storage server 120 stores driving habit data collected in real time by the driving habit data collection unit 110. Driving habits data may be stored in the cloud, such as Amazon Web Service (AWS) S3 storage, or in a separate server. The file is in the form of a Jason (.json) file of the driving habit collection device 100. Driving habit data (.json) may be stored in a converted form into csv (comma-separated value) using an AWS Lambda function in the process of importing it to the driving habit data storage server 120.

The main server 200 includes a main database 210 for receiving the driving habit data of the driving habit data storage server 120; a data pre-processing unit 220 that pre-processes the driving habit data of the main database 210 and extracts characteristics as necessary to create processed data; an artificial intelligence model 230 for predicting the accident risk of vehicle driving by inputting the data pre-processed in the data pre-processing unit 220; an accident risk database 240 for storing the accident risk output from the artificial intelligence model 230; and a control unit 250 that manages accident risk prediction by controlling the components of the main server.

The main database 210 receives the driving record of the driving habit data storage server 120. In the embodiment of the present invention, the main database 210 and the driving habit data storage server 120 are separated, but may be formed integrally.

The data pre-processing unit 220 preprocesses driving habit data, and in the case of a machine learning model, extracts characteristics from the preprocessed data to create processed data. Pre-process and feature extraction will be described later.

The artificial intelligence model 230 may be a machine learning-based model or a deep learning-based model, which will be described later.

The accident risk database 240 stores an accident risk that is an output value predicted through the artificial intelligence model 230 .

The control unit 250 controls the process of the main server 200 receiving the driving habit data and outputting the accident prediction value from the artificial intelligence model 230 .

The insurance server 300 may differentiate car insurance premiums for each driver based on the accident prediction value that is the output value of the artificial intelligence model from the main server 200.

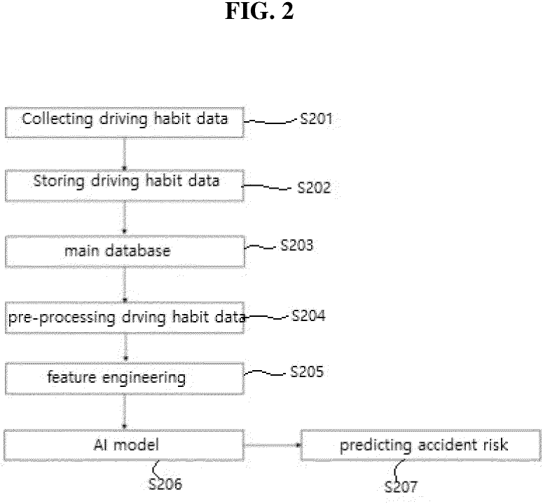

FIG. 2. is a flowchart illustrating a method of predicting the future accident risk rate of the drivers using artificial intelligence according to an embodiment of the present invention.

Referring to FIG. 2, the driving habit data collection device 100 collects and stores vehicle driving habit data through the driving habit data collection unit 100 while the driver drives the vehicle ( S201 ). The format of the driving habit data file is in the form of a json (json) file.

When the driving of the vehicle is completed, the vehicle driving habit data is stored in the driving habit data storage server 120 (S202). Driving habits data storage server 120 may be AWS (Amazon Web Service) S3 storage. The vehicle driving data (.json) in the form of a Jason (.json) file is converted into csv (comma-separated value) by using the AWS Lambda function in the process of importing it to the driving habit data storage server 120.

The stored vehicle driving habit data (.csv) is structured in which all variables per one trip are included. In the present invention, a data set generated from the entire process from starting the vehicle, driving the vehicle, and ending the engine is defined as a trip.

Next, the driving habit data storage server 120 transmits the stored vehicle driving habit data to the main database 210 of the main server 200 (S203).

Next, the data pre-processing unit 220 of the main server 200 performs a pre-processing of the vehicle driving habit data (.csv) (S204). Vehicle driving habit data (.csv) is composed of all variables per trip. To make it easier to handle, preprocessing is performed to convert each variable into a separately defined array. A detailed description of the preprocessing will be described later.

Further, when the pre-processing operation is completed in the data pre-processing unit 220 of the main server 200, feature engineering (S205) is performed. In order to apply it to the artificial intelligence model, features are extracted by using domain knowledge about vehicle driving habit data.

In the feature engineering step (S205), driving habit data, such as global positioning system (GPS) data, inertial measurement unit (IMU) sensor data, and vision sensor data, are processed as an average value rather than a time series to facilitate model analysis. The lower the model variables and complexity of the model, the easier it is to interpret the model results. In addition, standardization work is also performed so that the AI model can learn more easily.

In the case of deep learning models, artificial intelligence understands and judges information about data features by itself. On the other hand, in the case of a machine learning model, there is a part that needs to be directly input, so in order to apply the machine learning model, it has a feature engineering stage by using domain knowledge.

Next, the preprocessed data is input to the artificial intelligence model 230 of the main server 200 (S206) to obtain an output value. By putting one trip as an input value in the artificial intelligence model 230, an output value that is a single probability value between 0 and 1 is derived.

Next, the main server 200 stores the output value in the accident prediction database 240, and predicts the accident risk of the driver’s vehicle using this (S207).

Specifically, when one driver drives several times, a trip is defined for each driving and a probability is derived for each trip, which leads to an accident probability distribution of each driver. The median value is taken from this accident probability distribution to calculate the overall accident risk of the driver.

Hereinafter, each step will be described in detail.

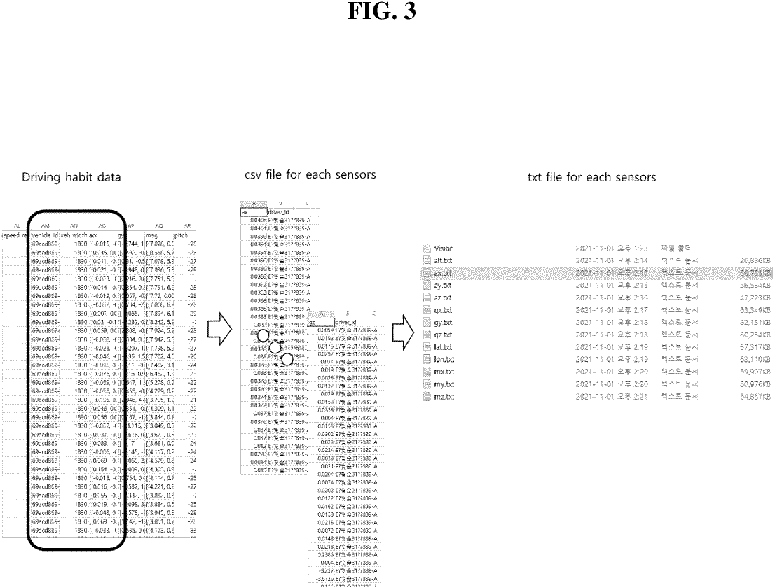

FIG. 3 is a diagram illustrating a data processing method in a preprocessing process according to an embodiment of the present invention.

Referring to FIG. 3, the driving habit data collected every second is initially stored in a Jason (.json) format file (S201). This file is converted into a csv file using a function implemented as a serverless computing service called AWS Lambda, and stored in the driving habit data storage server as the trip defined above (S202) and sent to the main database (S203).

In the main server, in order to put input values into the artificial intelligence model for each trip, the pre-processing unit performs preprocessing (S204) to convert each variable into an array form.

In the data pre-processing step S204, since there is a limit of memory to take all of the driving time of drivers into account, each sensor value is efficiently stored in a csv format as a time frame once every predetermined time (e.g., 5 seconds). The reason for storing data corresponding to a time frame of a certain time as a median value rather than an average value is that a smoothing effect occurs when the average value is stored, which can act to alleviate the popping data values. In addition, since thousands of driving records are accumulated depending on the driver on a monthly basis, a parallelizable dask library is used to effectively pre-process this large amount of data.

Then, all csv files corresponding to the same sensor value are merged and finally saved in the form of a txt file for each sensor value.

The AI model used in the AI model application step S206 includes a machine learning-based model such as a random forest and XGBoost, and deep learning-based models such as MLP (Multi-Layer Perceptron), LSTM (Long Short Term Memory), and CNN (Convolutional Neural Network). When a machine learning model is given training data, it finds a pattern in it, builds a specific model, and makes a decision based on the built model when new data is input. On the other hand, deep learning learns and predicts features by itself without inputting features to learn.

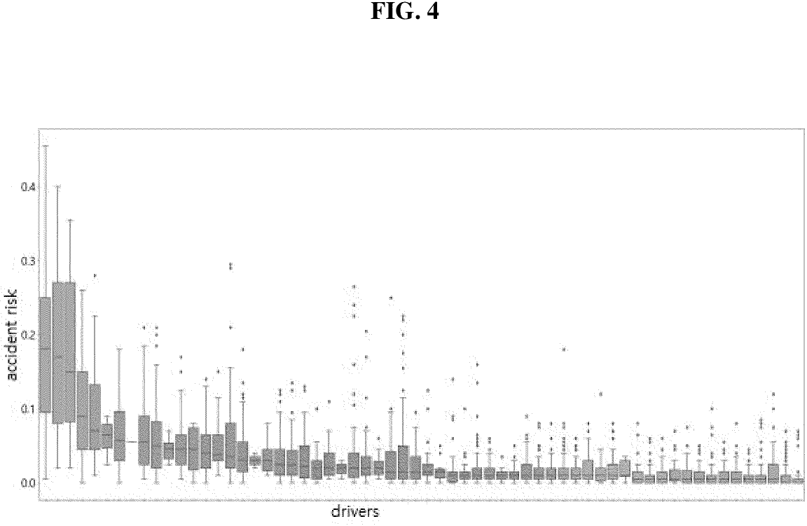

FIG. 4 is a diagram illustrating an output result of a random forest model according to an embodiment of the present invention.

Referring to FIG. 4, through a random forest model that is an artificial intelligence model 230 from driving habit data for each driver from a Global Positioning System (GPS), an Inertial Measurement Unit (IMU) sensor, and a vision sensor, the accident risk is predicted with a probability between 0 and 1 for each driver.

Finally, it is classified into driving safely and driving with a risk of causing an accident by a given threshold based on accident risk. That is, there will be several driving histories for each driver, and an accident risk is defined for each driving histories.

In the present invention, the accident risk database 240 is updated as the driving habit data increases.

When the distribution of a class appears unbalanced during data classification, it is called imbalanced data. A representative method for dealing with imbalanced data is to assign different weights to each class or oversampling or undersampling the data when learning. However, these methods are not used in the present invention. Only in the random forest model, the threshold required for the classification task is additionally set as a hyperparameter for training.

In the present invention, random forest and XGBoost are implemented as machine learning-based models.

The random forest algorithm uses bootstrapping to sample data multiple times, then learns decision trees for each sample, and generates one result based on each prediction result.

The XGBoost algorithm is a boosting technique based on CART (Classification and Regression Tree).

In the feature engineering work for these two models, respectively, as described above, the defined sensor average values rather than the time series are input as input features and trained. Hyperparamenter tuning is also performed to maximize learning performance.

In the present invention, as a deep learning-based model, Multi-Layer Perceptron (MLP), Long Short Term Memory (LSTM), and Convolutional Neural Network (CNN) are implemented. The input features are the same as in the above-described machine learning model.

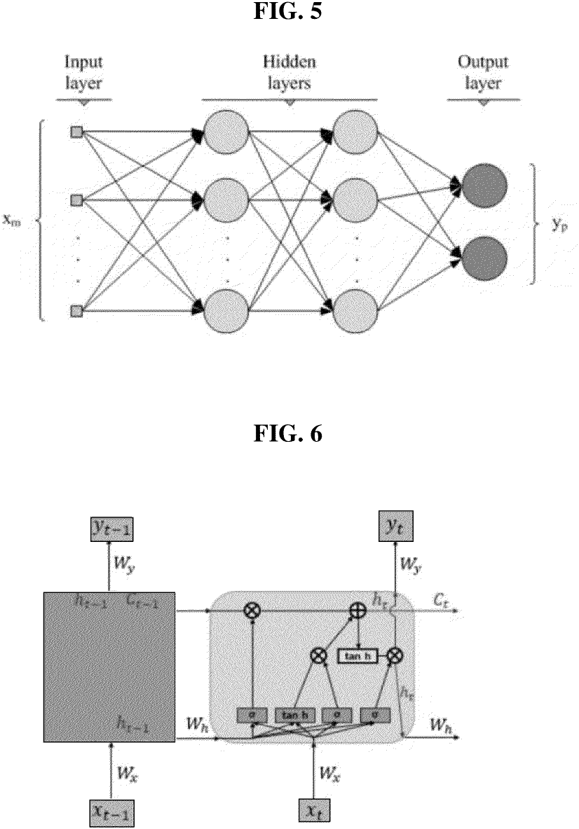

FIG. 5 is a diagram illustrating a Multi-Layer Perceptron (MLP) algorithm according to an embodiment of the present invention. The MLP algorithm is an algorithm that extracts features suitable for learning more from data through more calculations by inputting several hidden layers in the middle in the basic artificial neural network model of deep learning.

Referring to FIG. 5, for each node in each layer, input values of all input nodes are received, a weighted sum is calculated, and this value is applied to an activation function and transmitted as an output value. Finally, it learns by updating all the existing weights by using a technique called gradient descent to receive the predicted value from the output layer and minimize the difference from the actual value.

FIG. 6 is a diagram illustrating a Long Short Term Memory (LSTM) algorithm according to an embodiment of the present invention. The LSTM algorithm is a model modified based on a Recurrent Neural Network (RNN), and is a deep learning algorithm mainly used for sequence prediction.

Referring to FIG. 6, there are a hidden state and a cell state, and the vanishing gradient problem of the RNN model is solved through an input gate, an erase gate, and an output gate. The input gate and the erase gate are gates that decide whether to remember or forget the present and past information, respectively. After updating the cell state (Ct) based on these, the hidden state (ht) at the present time is obtained through operation with the output value that has passed through the output gate. In the present invention, the driver’s accident risk is finally predicted by adding linear layers on the LSTM model. In FIG. 5, ‘xt-1’ and ‘xt’ are input vectors of the input layer at time t-1 and t, ‘yt’ and ‘yt-1’ are output vectors of the output layer at time t-1 and t. ‘Wx’, “Wh’, and ‘Wy’ are weights in the input layer, hidden layer, and output layer. ‘σ’ means a sigmoid function, and ‘tanh’ means a hyperbolic tangent function.

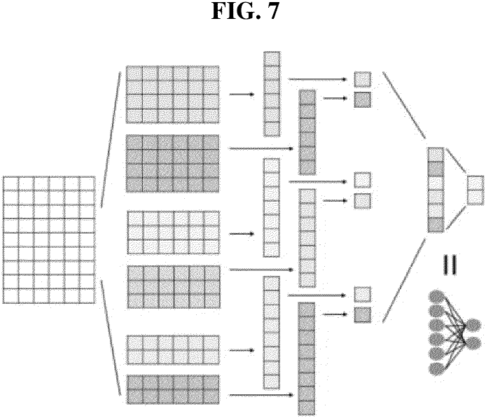

FIG. 7 is a diagram illustrating a 1D Convolutional Neural Network (CNN) algorithm according to an embodiment of the present invention. The 1D CNN algorithm is a model converted from the 2D CNN algorithm mainly used when dealing with images or videos so that it can be applied to natural language processing or time series data.

Referring to FIG. 7, similar to 2D CNN, it is an algorithm for extracting data features through convolution with a plurality of kernels or filters. In the present invention, the driver’s accident risk is finally predicted by adding several linear layers to the output value obtained from the CNN model.

Hereinafter, prediction performance of AI-based models according to an embodiment of the present invention is evaluated.

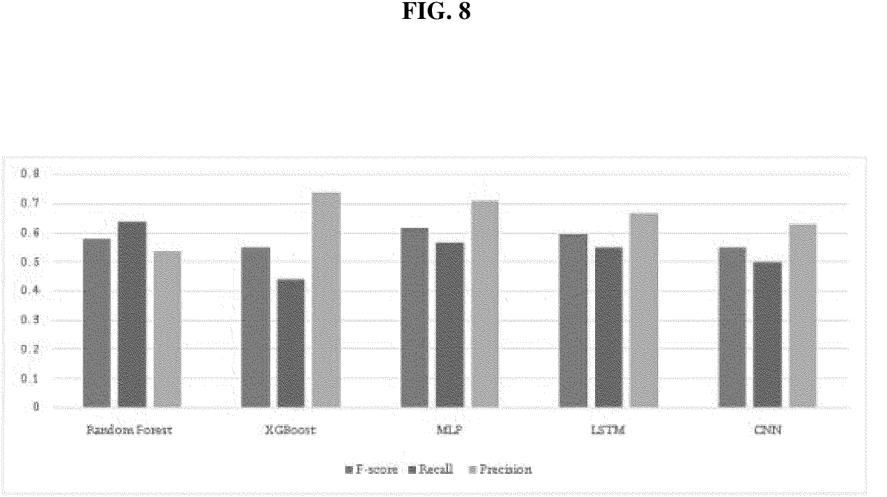

FIG. 8 is a diagram illustrating prediction performance of AI-based models according to an embodiment of the present invention.

Referring to FIG. 8, it was evaluated with an F-score. In imbalanced data, where data is imbalanced distributed by class, the performance of the trained model is measured not by accuracy but by prediction, recall, and their harmonic average, F-score.

In an embodiment of the present invention, the accident risk prediction performance was evaluated based on the driving habit data of taxi drivers for 6 months collected from the server. A more meaningful interpretation will be possible if the AI models of the present invention are learned using driving habit data from other data domains such as bus drivers, cargo drivers, and general drivers.

While the present invention has been particularly shown and described with reference to preferred embodiments thereof, it will be understood by those of ordinary skill in the art that various changes in form and details may be made therein without departing from the spirit and scope of the present invention as defined by the following claims.

What is claimed is:

1. A device of predicting the future accident risk rate of the drivers using artificial intelligence, comprising:
a driving habit data collection device comprising a driving habit data collection unit that has built-in GPS, IMU sensor, and a vision sensor to collect vehicle driving information per trip, and a CPU that manages the collection of driving habit data;
a driving habit data storage server for storing driving habit data collected from the driving habit data collection unit; and
a main server including a main database for receiving the driving habit data of the driving habit data storage server, a data pre-processing unit for pre-processing the driving habit data of the main database for each variable, an artificial intelligence model that predicts the accident risk of vehicle driving by inputting the data preprocessed in the data pre-processing unit, an accident risk database that stores the accident risk output from the artificial intelligence model, and a control unit that manages the accident risk prediction.

2. A device of predicting the future accident risk rate of the drivers using artificial intelligence of claim 1, wherein
each driving habit data pre-processed for each variable is longitude, latitude, and altitude from GPS;
accelerations in the x, y, and z-axis directions (ax, ay, az) from the IMU and angular accelerations in the x, y, and z-axis directions (gx, gy, gz); and
distance from the vision sensor to the front vehicle(front_distance), the speed of the front vehicle (front_speed), the bias of the subject vehicle in the center of the lane (bias), the estimated time until collision with the front vehicle (ttc).

3. A device of predicting the future accident risk rate of the drivers using artificial intelligence of claim 1, wherein
further comprising an insurance server that differentiates car insurance premiums for each driver based on the accident risk that is the output value of the artificial intelligence model from the main server.

4. A device of predicting the future accident risk rate of the drivers using artificial intelligence of claim 1, wherein
the vehicle driving data collected by the driving habit data collection device has a configuration including all variables per one trip,
the data pre-processing unit stores the data of each sensor value as a time frame once at a predetermined time so that it is easier to handle the driving habit data, and all files corresponding to the same sensor value are merged and stored as one file.

5. A device of predicting the future accident risk rate of the drivers using artificial intelligence of claim 1, wherein
the data pre-processing unit performs feature engineering, in the feature engineering, driving habit data is stored as an average value once at a predetermined time.

6. A device of predicting the future accident risk rate of the drivers using artificial intelligence of claim 1, wherein
the artificial intelligence model is any one selected from random forest, XGBoost, Multi-Layer Perceptron (MLP), Long Short Term Memory (LSTM), and Convolutional Neural Network (CNN).

7. A method of predicting the future accident risk rate of the drivers using artificial intelligence, comprising:
collecting driving habit data from the driving habit data collection device through a driving habit data collection unit having a GPS, IMU sensor, and vision sensor;
storing the driving habit data collected by the driving habit data collection device in a driving habit data storage server;
transmitting the driving habit data stored in the driving habit data storage server to the main database of the main server;
performing a pre-processing of driving habit data in the data pre-processing unit of the main server;
obtaining an output value by inputting preprocessed data into the artificial intelligence model of the main server; and
storing the output value of the artificial intelligence model of the main server in an accident risk database, and predicting the accident risk of the driver’s vehicle using the output value.

8. A method of predicting the future accident risk rate of the drivers using artificial intelligence in claim 7, wherein
the pre-processing in the data pre-processing unit of the main server is,
further comprising a generating processed data by performing a feature engineering of extracting features by using domain knowledge of driving habit data in order to apply them to the artificial intelligence model.
